(19) United States
(12) Patent Application Publication
(10) Pub. No.: US 2015/0208314 A1
(43) Pub. Date: Jul. 23, 2015

(54) METHOD FOR REDUCING SIGNALING MESSAGES AND HANDOVERS IN WIRELESS NETWORKS

(71) Applicant: Telefonica, S.A., Madrid (ES)

(72) Inventor: Javier Lorca Hernando, Madrid (ES)

(73) Assignee: Telefonica, S.A., Madrid (ES)

(21) Appl. No.: 14/424,541

(22) PCT Filed: Aug. 5, 2013
(86) PCT No.: PCT/EP2013/066370

§ 371 Date: Feb. 27, 2015

(30) Foreign Application Priority Data
Aug. 29, 2012 (ES) P201231340

(51) Int. Cl. H04W 36/32; H04W 64/00; H04W 48/04; H04W 36/04; H04L 5/00

(52) U.S. Cl. CPC H04W 36/32; H04W 36/04; H04L 5/0048; H04W 48/04; H04W 64/006; H04W 88/02

(57) ABSTRACT

The method comprising estimating, at least one wireless user device (UE) its own velocity from at least one downlink pilot signal being transmitted by any base station from a plurality of different base stations, and further comprising:—broadcasting each one of said plurality of different base stations a parameter relative to its own cell size;—performing said at least one wireless user device in idle mode cell selections and reselections based on said plurality of base station cell size parameters received and said at least one wireless user device estimated velocity; and—reporting, said at least one wireless user device in connected mode, said estimated velocity and cell sizes of neighboring base stations to a serving base station in order to perform handovers based on said reported estimated velocity and said neighboring base station cell sizes.

### FIELD OF THE ART

The present invention generally relates to wireless networks data transmission, and more particularly to a method for reducing signaling messages and handovers in wireless networks by estimating, at least one wireless user device its velocity from a downlink pilot signal from a plurality of base stations.

### PRIOR STATE OF THE ART

As the spectral efficiency of a point-to-point link in cellular networks approaches its theoretical limit, there is a need for an increase in the node density to further improve network capacity. However, in already dense deployments in today's networks, cell splitting gains can be severely limited by high inter-cell interference.

An alternative approach involves the deployment of low power nodes overlaid within a macro network, creating what is referred to as a heterogeneous network (commonly known as “HetNet”). HetNets consist of a mix of macrocells, remote radio heads, and low-power nodes such as picocells, femtocells, and relays operating in the same or different frequencies. Increasing the proximity between the access network elements and the end users has the potential to dramatically increase overall throughput and spectrum efficiency per square km. Operating the layers in different frequencies alleviate most interference issues, however major technical challenges appear when dealing with mobility between layers.

Mobility management becomes a complicated issue in HetNets due to several reasons. When the layers are deployed in different frequencies, appropriate gaps are required for inter-frequency measurements which cause interruptions and make the handover process more costly [1]. If the layers are deployed in the same frequency, mobility is easier to manage but interference problems may appear, making it important to carefully control the point at which handovers and reselections take place. It is thus of vital importance to control mobility so that inter-layer handovers are performed only when strictly needed.

Additionally, the existence of a number of small cells (micro. pico or femto cells) in the coverage region of a macrocell may originate a high amount of signalling exchange due to mobility procedures (such as location/routing/tracking area updates), even if the users are in Idle state.

### Problems with Existing Solutions

One very important issue when dealing with small cells is mobility management for fast moving users. These users may enter the coverage region of a small cell for a very limited time interval before being rescued again by the macro coverage. Even in idle mode, eventual location/routing/tracking area updates involve a high signaling load in a very short period of time. Connected mode users can also experience significant interruptions due to handovers, especially if the macro cell and the small cells operate at different frequencies/RATs.

One possible solution is to keep fast moving users in the macro layer whenever possible, being handed over to the small cells layer only if the radio conditions force to do so. Idle mode fast moving users should also be kept under control of the macro layer in order to avoid an excessive amount of idle mode signaling exchange. Both solutions involve appropriate velocity estimations for idle and connected mode users, and radio resource management (RRM) strategies that incorporate velocity estimations as inputs for mobility decisions.

Some RRM techniques have been proposed. as in US 2011/0211560 that take cell sizes into account for handover decisions. In this solution, smaller-sized cells are favored in handovers provided that the serving cell has information of the neighbour cell sizes. However no velocity information is taken into account, only proposing to offload macro cell users towards small cells if the radio conditions are appropriate. Moreover, only connected mode is dealt with in this proposal, while idle-mode users frequently represent a source of heavy signaling traffic when performing periodic location/routing/tracking area updates.

Several solutions for velocity estimation have been proposed in the literature [3] [4] and in patent application US 2011/0009071. However no linkage between them and any RRM strategy has been proposed so far, apart from the speed-dependent scaling of the reselection/handover parameters in 3GPP standards [1]. As an example, it is provided in LTE a speed-dependent scaling of the reselection and handover parameters that the UE applies based on its estimated velocity [5][6]. The scaling applies in both idle mode and connected mode, through modification of the parameters T_{reselection}, Q_{hyst} and TTT (time to trigger). This velocity is simply calculated from the number of reselections and handovers over a defined period of time, excluding consecutive reselections/handovers between the same two cells. Hence it only takes place after a certain number of cell changes and the UE may result in too-early or too-late handovers before such estimation. Priorities for reselections/handovers are however not considering the UE speed, which would make much sense in heterogeneous scenarios.

Some solutions as the proposed in US 2009/0310505 try to estimate the rate of variation of the line-of-sight (LOS) distance from the terminal to the base station. However this requires a synchronous mobile network and is based on line of sight between users and base stations, possibly failing in dense urban scenarios. Other solutions US 2008/0056390 and US 2005/0089124 propose to apply properties of the Rayleigh fading, such as the level crossing rate, for evaluation of the maximum Doppler frequency. This has the drawback of requiring strict Rayleigh properties, which are not always encountered in real scenarios. Finally, in US 2006/0114973 a mechanism is proposed for CDMA mobile receivers based on the power spectral density of the received pilot signals. This mechanism can be generalized to non-CDMA technologies and will serve as a basis for evaluation of the ideas proposed in this invention.

Other solutions exist for velocity estimation from the network side. These solutions are based on air-interface analysis of the uplink received signals. Such measurements require a periodic uplink transmission, and the Sounding Reference Signals (SRS) may help for that purpose [8]. However this requires periodicities of a few milliseconds in the SRS transmissions so that the network is able to detect velocities of the order of 100 km/h, thus decreasing battery life if estimations are performed over a long time.

The presence of femto cells in the coverage region of a macro cell introduces an additional complexity: as UEs may reselect to an open access femto cell when entering its coverage region, significant signaling load will occur with idle-mode high-speed users continuously going in and out of the femto coverage.

In view of present state of the art, more efficient RRM solutions must be investigated that take into account not only cell sizes or signal levels, but also the user's velocity for handovers and reselections, both in idle mode and connected mode.

### SUMMARY OF THE INVENTION

It is necessary to offer an alternative to the state of the art which covers the gaps found therein, particularly those related to the lack of proposals which allow a method for cell reselection and handover based on mobility estimation for wireless mobile networks based upon the user's mobility estimation and some information exchange between base stations and user devices.

To that end, the present invention relates to a method for reducing signaling messages and handovers in wireless networks, comprising estimating as commonly used in the state of the art, at least one wireless user device (UE) its own velocity from at least one downlink pilot signal being transmitted by any base station from a plurality of different base stations.

On contrary to the known proposals, the method in a characteristic manner further comprises:
broadcasting each one of said plurality of different base stations a parameter relative to its own cell size;
performing said at least one wireless user device in idle mode cell selections and reselections based on said plurality of base station cell size parameters received and said at least one wireless user device estimated velocity; and
reporting, said at least one wireless user device in connected mode, said estimated velocity and cell sizes of neighboring base stations to a serving base station in order to perform handovers based on said reported estimated velocity and said neighboring base station cell sizes.

In a preferred embodiment, when said at least one wireless user device estimated velocity is above a given threshold indicative of fast moving conditions said cell reselection is limited to large or medium-size cell base stations and said serving base station performs said handovers in order to steer said at least one wireless user device to said large or medium-size cell base station.

In another preferred embodiment, when said at least one wireless user device estimated velocity is below a given threshold indicative of static conditions said cell reselection is limited to a small-size cell base station, and said serving base station performs said handovers in order to steer said at least one wireless user device to said small-size cell base station.

The cell size parameter, in another embodiment, can be broadcasted as part of a suitable information element (IE) contained within a Broadcast Control Channel (BCCH) in a UMTS or in a LTE network or broadcasted in a separate information element.

The cell size parameter is a relative measure of the effective cell size considering a transmission power and a carrier frequency and it can be expressed in terms of a useful measure such as an average surface area, an identifier taken from a list of possibilities or half the distance to the nearest neighbour, among others.

In another preferred embodiment, the estimated velocity can be sent in a periodic or in an aperiodic way in a suitable uplink control/data channel upon request from said serving base station.

Also, the estimated velocity is calculated based upon observation of a downlink cell reference signal selected among LTE cells, a Common Pilot Channel (CPICH) in UMTS/HSPA cells or a pilot in a radio access technology among others.

In another preferred embodiment, the cell sizes of neighboring base stations are reported by said at least one wireless user device as part of the measurement reports upon request from said serving base station.

Finally, in yet another embodiment, the downlink pilot signals are constantly broadcast by said plurality of base stations and in order to calculate the estimated velocity it comprises finding an estimated maximum Doppler frequency from said downlink pilot signals by performing a Fourier transform of the autocorrelation of a channel transfer function H(f;t) calculated from said downlink pilot signals.

Other embodiments of the method of the present Invention are described according to appended claims and in a subsequent section related to the detailed description of several embodiments.

### BRIEF DESCRIPTION OF THE DRAWINGS

The previous and other advantages and features will be more fully understood from the following detailed description of embodiments, with reference to the attached, which must be considered in an illustrative and non-limiting manner, in which:

FIG. 1 is a heterogeneous network comprising several cells with different sizes and/or frequencies or RATs, and a large macro cell including the coverage regions of several micro/pico/femto cells representing the global scenario for application of the proposed invention.

FIG. 2 is a flow diagram of the basic idea of the proposed invention when the UE is in idle mode.

FIG. 3 is a flow diagram of the basic mechanism proposed in this invention for connected mode users.

FIG. 4 is a flow diagram for the case of mobility-based cell reselection in Idle mode, according to an embodiment.

FIG. 5 shows the case of the velocity reporting in connected mode, according to an embodiment.

FIG. 6 is a schematically illustration of the proposed idea of reporting neighbour cells' sizes as part of the corresponding measurement reports.

FIG. 7 is a representation of the channel impulse response, denoted as h(τ;t) and being defined as the output obtained as a response to a Dirac delta at time t.

FIG. 8 is the proposed structure for velocity estimation, according to an embodiment.

FIG. 9 is a graphical representation of the proposed structure for the circular buffer in FIG. 8. and

FIG. 10 represents the contents of this circular buffer after storing a number of channel values greater than N.

FIG. 11 is a simplified block diagram for velocity estimation, according to an embodiment.

FIG. 12 is an example embodiment of the proposed invention, characteristic of a wireless mobile communication system comprising a plurality of base stations and a user terminal.

### DETAILED DESCRIPTION OF SEVERAL EMBODIMENTS

The present invention proposes an enhanced method for cell reselection and handover in wireless mobile networks, based upon the user's mobility estimation and some information exchange between the base stations and the user terminals. Procedures for idle mode and connected mode are proposed in order to optimize mobility management in heterogeneous scenarios.

The “CELL_SIZE” parameter has to be understood as the proposed parameter to be broadcast by the base station, indicating a measure of the relative cell size with any desired granularity. The velocity indicator refers to the proposed indication sent by connected mode UEs to the serving base station, aimed at reporting velocity in order to enable mobility-based RRM strategies. Finally, by neighbour cells' size report it has to be understood the proposed report containing neighbour cells' size indications broadcast by the neighbour base stations, and included as part of the connected mode measurement reports.

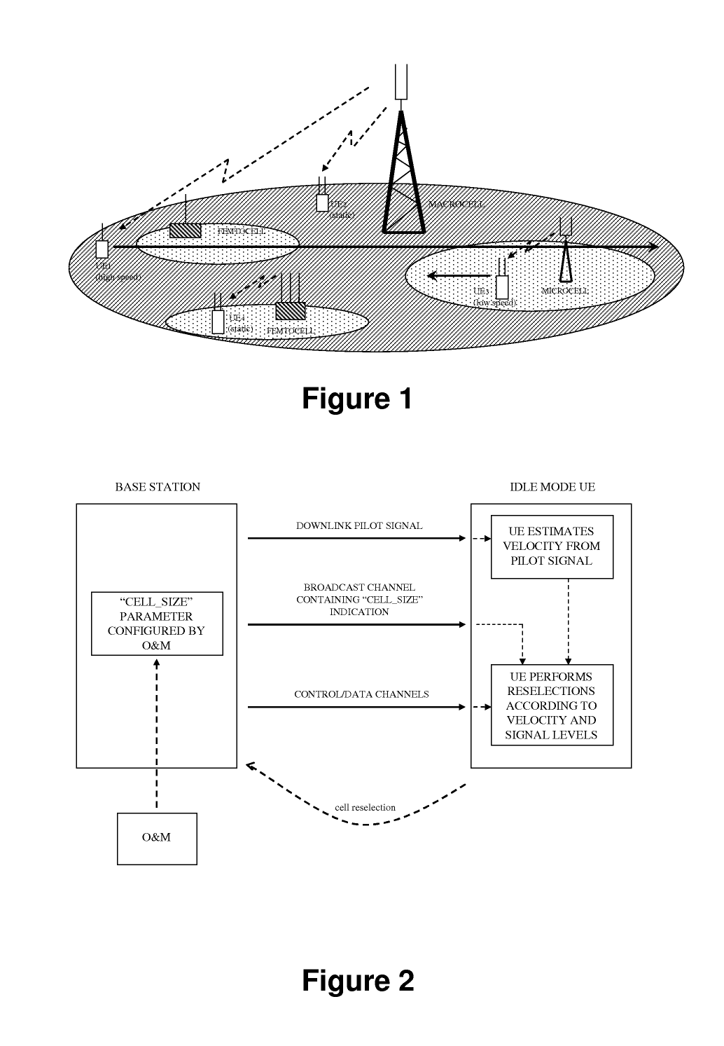

FIG. 1 depicts in an embodiment the global scenario for application of the proposed invention. A heterogeneous network comprises several cells with different sizes and/or frequencies or RATs, and a large macro cell including the coverage regions of several micro/pico/femto cells. Different types of users may be considered according to its mobility: high speed users (as UE1 in the figure), static users (as UE2 and UE4), and low speed users (as UE3). UEI crosses several cell borders but is located in the coverage zone of the macro cell; hence it should be kept in the macro if continuous cell reselections and handovers are to be avoided (especially if the small cells operate at different frequencies). UE2 is a static macro user and UE4 a static femto user; both of them should be kept in their best cells (macro and femto respectively). Finally UE3 is a low speed user located in the coverage zone of a micro cell; as the user moves slowly several cell changes can be needed in order to keep it with the best radio conditions.

UEs in a similar situation as UE1, if maintained within the macro, may be forced to operate in bad radio conditions if the cells share the same carrier frequency. In these cases it should be necessary to incorporate advanced receiver functionalities in the UE, aimed at cancelling interference to a certain degree. UEs operating in heterogeneous scenarios will very likely implement interference cancellation, as happens also with so-called cell range expansion (CRE) [10].

FIG. 2 depicts an embodiment of the basic idea of the proposed invention when the UE is in idle mode. In a mixed scenario comprising macro, micro, pico and/or femto cells (belonging to one or several frequencies/RATs), the base stations broadcast a new parameter, namely “CELL_SIZE”, by means of a suitable broadcast control channel (such as BCCH in UMTS and LTE). This parameters contains a static indication of the cell size with any desired granularity: it can consist of a discrete set of indications (such as e.g. “large”, “medium” or “small”), or express the approximate radius (in m) characterizing the coverage region (such as e.g. “10-20” for femtos or “200” for macros/micros). This indication may thus be read by UEs in idle mode for eventual cell selections and reselections. With the aid of cell size indicators, the terminals may or may not perform cell reselection to a given cell depending on Its size and the user's speed, which can be estimated by suitable analysis of the downlink pilot signals from the UE. Small sized cells could therefore be selected only if the speed is below a certain threshold, indicative of the moving conditions, in order to avoid subsequent additional NAS traffic (such as location/routing/tracking area updates).

UEs in connected mode are expected to perform periodic or event-triggered neighbour cell measurements, aimed at helping the network in eventual handover decisions. Blind handovers are also possible in which no measurements are reported, and the network performs handovers without any feedback from the UE [1]. Actual handover algorithms are implementation-specific, but no velocity information is considered so far in the standards.

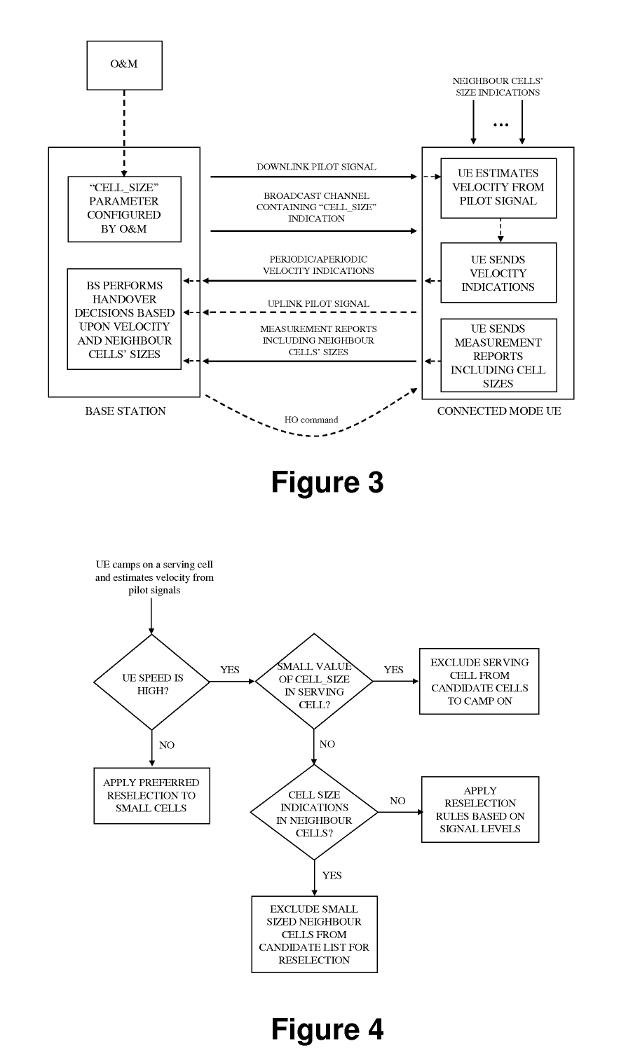

In this context, FIG. 3 depicts in another embodiment the basic mechanism proposed in this invention for connected mode users. The UE estimates its velocity from pilot signals and reads the “CELL_SIZE” parameter broadcast by the neighbour cells. When the UE sends periodic or event-triggered measurement reports (as commanded by the network), information about the neighbour cells' sizes is included. Additionally, the network instructs the UE to send the estimated user's velocity in a periodic or aperiodic fashion. Optionally, the base station may take advantage of uplink pilot signals sent by the UE (or signals eventually playing this role, such as the Sounding Reference Signals in LTE), In order to enhance the estimated velocity value given by the UE. The base station can take advantage of all this information for eventual speed-dependent handover decisions.

Estimation of the user's speed from the UE may be based upon observation of the downlink cell reference signals (for LTE cells), CPICH signals (for UMTS/HSPA cells), or any other pilots in the radio access technology under consideration. These pilot signals are constantly broadcast by the cells and may be used for calculation of the channel transfer function H(f;t). In this case, if more than one TX antenna is employed in the cell, there would be more channel transfer functions (one for each TX-RX pair). However it would suffice to perform the velocity estimation over one of the available transfer functions. This function will in general vary over time as mobile channels are not invariant, and its autocorrelation can be computed as a function of the time difference Δt [2]. The Fourier transform of the autocorrelation gives the estimated Doppler spectrum as a function of the Doppler frequency, and its width is directly proportional to the user's speed [7]. An example of velocity estimation procedure is shown based upon observation of the downlink pilot signals; therefore it should be equally valid for both idle mode and connected mode users.

In connected mode, handovers are controlled by the access network upon measurements provided by the UEs when radio conditions encourage the search for a better cell. Therefore the network should be aware of the terminal's speed so as to order appropriate intra-RAT or inter-RAT handovers. Mobility could also be estimated by the base station if uplink pilot transmissions from the UE are sufficiently continuous so as to enable calculation of the autocorrelation function at the relevant time shifts.

In order to estimate velocity in idle mode, the UE should temporarily reduce or even cancel Its DRX period (If existing) In order to perform the necessary measurements. As this may require significant processing resources, the UE should only perform velocity estimations during a limited period of time when suitable “CELL_SIZE” parameters are found. Velocity estimations in connected mode should only represent a negligible increase in the global processing power required for normal operation.

The present invention introduces mobility management enhancements especially suited for heterogeneous wireless networks, comprising cells with (possibly) different sizes, frequencies and/or technologies. The following proposals are introduced:
1. Base stations shall broadcast a new parameter (denoted as “CELL_SIZE” in what follows) In any suitable broadcast control channel, such as BCCH in UMTS and LTE. This parameter represents a relative measure of the effective cell size, taking into account the transmission power and the carrier frequency. The cell size can be expressed in terms of any useful measure, such as e.g. the average surface area (in m) or half the distance to the nearest neighbour (in m).
2. Idle mode users, upon evaluating neighbour cells for eventual reselections, shall read the corresponding broadcast control channels and decode the cell size indications. Additionally, the UE shall estimate its own speed based on the analysis of the received downlink pilot signals.
3. According to the estimated velocity and the relative sizes of the neighbour cells, idle mode UEs can perform suitable cell reselection strategies taking velocity into account. As an example, the UE may not reselect to a small sized cell when Its velocity is above a certain threshold, and Inversely the UE may reselect to a small cell whenever its velocity is considered very low.
4. Connected mode users shall also read and decode the neighbour cells' size Indications, and estimate Its velocity from the pilot signals. Velocity shall then be reported to the base station in a periodic or aperiodic way in any suitable uplink control/data channel, upon request from the serving base station. Neighbour cell sizes shall also be sent to the base station as part of the corresponding measurement reports. The serving base station can thus take into account the relative sizes of the neighbour cells as well as the user's velocity in order to perform handover decisions.

Additionally, an example of velocity estimation procedure is detailed based on analysis of any suitable pilot signal, which may be applied as part of an exemplary embodiment in following paragraphs. This procedure may also be applied in uplink if conditions are met for application of the proposed method. Any other velocity estimation procedure is also equally valid for the purposes of the present invention.

The present invention describes methods and apparatus aimed at properly implement the above described functionalities. The granularity of the CELL_SIZE indications can be implementation-specific, including the following possibilities:
CELL_SIZE may be one of a discrete set of possibilities, such as e.g. “small”, “medium” and “large” (or “macro”, “micro”, “pico” and “femto”).
CELL_SIZE may be an Integer expressing the approximate cell size (in meters or square meters) according to the operational frequency. A cell size in meters can express half the distance to the nearest neighbour, and a cell size in square meters can measure the approximate cell surface area. This size cannot obviously be determined precisely, but an indication of its order of magnitude can suffice.

Cell size Indications may be broadcast as a part of any suitable Information element (IE) contained within the broadcast control channel, or in a separate IE. The presence of this element enables mobility-based RRM strategies in both idle and connected modes, but also other policies for cell selection (for example, the network might keep low-end terminals in the macro layer and reserve higher-featured phones for small hotspots).

Broadcast cell sizes are inherently static. Hence the network may instruct connected-mode UEs to report neighbour cell sizes only if no previous size indications were stored by the corresponding serving base station, depending on actual Implementations.

Velocity, on the other hand, should be dynamically reported by UEs in connected mode. The network can therefore trigger periodic or aperiodic velocity reports to be sent by the UE in a suitable uplink control or data channel. Velocity indications should not be sent much frequently, hence time periods of the order of several seconds should suffice for periodic velocity reporting. The granularity for the reported velocity values may be suited for specific needs, such as e.g. dividing the maximum range Into several Intervals and assigning different bit sequences for each of them.

Mobility-based cell reselection in idle mode:

An idle mode user can read a neighbour cell's size indication from the corresponding broadcast channel, as well as estimate its velocity from the serving cell's pilot channel. According to the resulting velocity estimation, usual cell reselection rules can be modified in order to avoid reselecting to a small sized cell when velocity is above a certain threshold. Conversely, users with sufficiently slow velocity can camp on any cell disregarding its size. FIG. 4 depicts an example embodiment of this situation.

After connecting or camping on a serving cell the UE estimates its velocity from the corresponding pilot signals. If the UE speed is not high (whatever the criteria employed for velocity evaluation), the UE may preferably reselect to any small cell in its surroundings, including the present serving cell. This helps to offload the macro layer by locating static (or nearly static) users in the small cell layer, whenever possible.

If the estimated velocity is high, the UE then evaluates the CELL_SIZE indication as broadcast by the serving cell. If such indication exists and the corresponding cell size is small, the UE tries to reselect to a different neighbour cell excluding the present cell from the candidate cell list or assigning the lowest priority for it (although its actual ranking may be better than the neighbours' ranking, when such ranking is applied [5]). If the advertised cell size is not small (or no serving cell indication exists), the UE evaluates eventual neighbour cells' size indications, and whenever present the UE excludes small-sized cells from being eventual candidates for cell reselections, if radio conditions allow to do so. If no cell sizes are present the UE applies usual call reselection rules based on signal levels, as specified in the standards.

Velocity and neighbour cells' size reporting in connected mode:

In connected mode the network Is in charge of moving the user to the best suitable cell. Mobility information should be an important criterion for moving users in heterogeneous scenarios. The network may estimate the user's velocity in some cases, when uplink transmissions are sufficiently continuous so as to enable accurate calculations at the base stations. However this cannot always be assumed as bursty traffic is the most typical data pattern in connected mode. There are exceptions to this, as in circuit-like connections or when the network instructs the UE to periodically send a pilot-like signal for estimation (such as the Sounding Reference Signal in LTE [1]). However this is not necessarily assumed either.

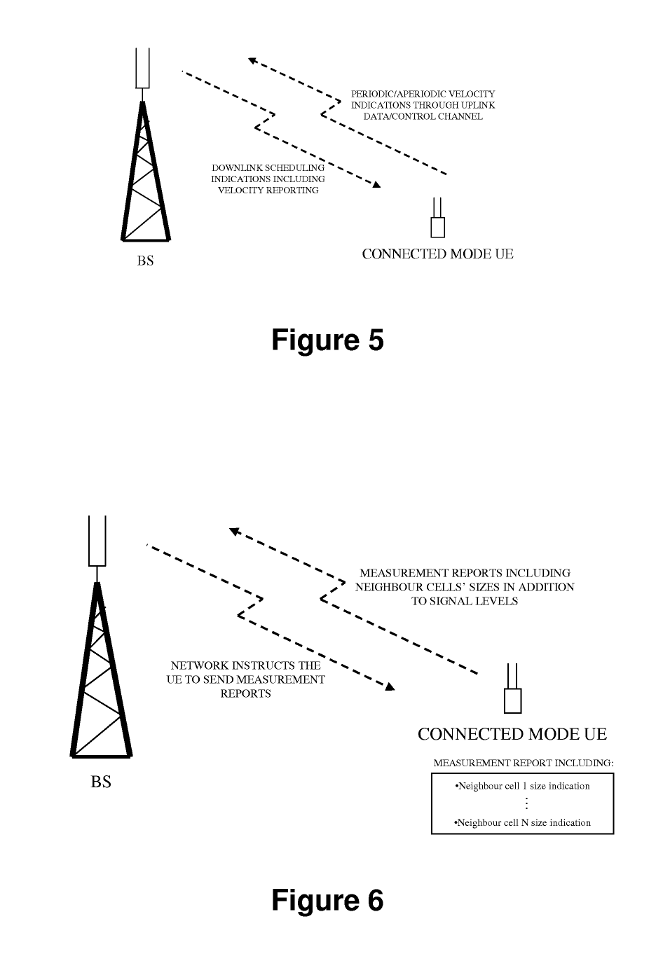

Velocity indications are thus proposed to be reported by the UE, as depicted in FIG. 5. This information may be carried over a suitable uplink control or data channel, with a granularity and periodicity to be defined by actual implementations. The network may instruct the UE to report velocity on a periodic or aperiodic basis, e.g. through a suitable scheduling indication.

As velocity cannot vary very quickly, this information may be reported over large time periods (of the order of several seconds), hence the overhead should be extremely low. The periodicity for velocity estimations should be related to the actual time required by the UE to derive estimations, as shown in proposed structure for velocity estimation.

Velocity indications should not be contained within measurement reports, because these only appear when the network instructs to measure other cells due to poor serving signal quality. Velocity indications should be reported even in good serving signal conditions in order to evaluate eventual handovers due to mobility. In this case the network should first instruct the UE to report neighbour cells' sizes as part of the corresponding measurement reports, as explained below. The network should be aware of the neighbour cells' sizes in addition to the user's velocity, for eventual application of velocity-based handovers. FIG. 6 schematically depicts the proposed idea of reporting neighbour cells' sizes as part of the corresponding measurement reports.

The new modified measurement reports can comprise any suitable structure, provided it conveys appropriate cell sizes (if broadcast by the cell) as part of the usual measurements.

Measurement configuration can be signalled via specific radio resource control messages, as e.g. “RRCConnectionReconfiguration” in LTE [1]. The network may send this message only when no cell size information has been sent by the UE in the past, as cell size ndications should not change over time.

Example of velocity estimation procedure:

This example of velocity estimation mechanism can be performed by the UE with any desired accuracy, which is a trade-off between processing capabilities, time required for velocity estimation and battery use. It can also be performed by the network when some conditions are met by uplink transmissions. However the preferred implementation for this invention is UE-based velocity estimation, because in this case no extra transmit power is needed, but network-based velocity estimation is not precluded and would require no modifications. In what follows, UE-based velocity estimation is assumed.

It is also assumed that the UE is able to track the corresponding pilot signals employed for channel estimation (such as cell reference signals for LTE, CPICH for UMTS, preamble or pilots for IEEE 802.16, and so on). With the aid of pilot signals the UE is able to obtain and store the relevant channel transfer functions. If more than one antenna is employed for transmission or reception, it is sufficient to store only one of the available transfer functions. It is also possible that the UE has to modify its DRX parameters in order to wake up its receiver with the periodicity required by the proposed method (which can be parameterized as explained in the design rules for N, M, L and ΔT paragraphs).

Theoretical Background:

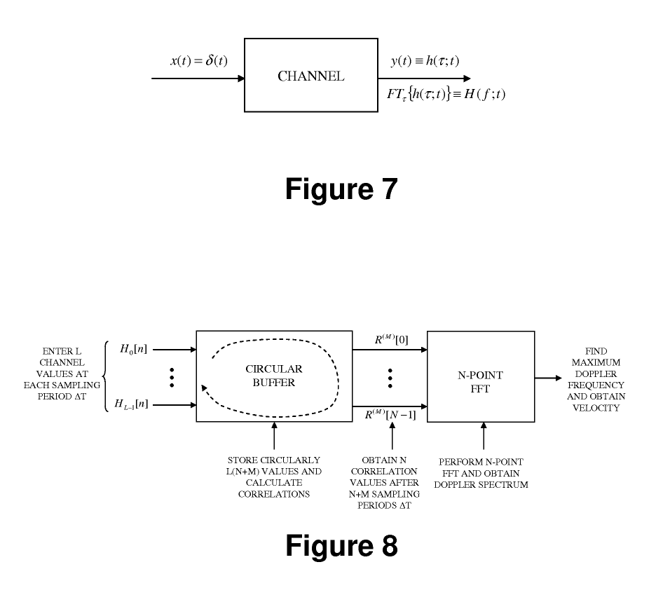

In what follows the channel impulse response will be denoted as h(τ;t), being defined as the output obtained as a response to a Dirac delta at time t (see FIG. 7).

x(t)−δ(t) [symbol] y(τ;t)−h(τ;t)

The output of that function is a function of time t because the channel is in general variant, and also a function of the time delay τ. As is usually encountered in mobile radio channels, there are multiple discrete propagation paths. Thus the impulse response takes the form [2]:

$$h ( τ ; t ) = {\sum }_{n}^{ } {α}_{n} ( t ) {e}^{j2π {f}_{c} {τ}_{n} ( t )} δ ( τ - {τ}_{n} ( t ) ) ,$$

where αₓ(t) is the attenuation factor for the nth path, τₙ(t) its propagation delay and f_{c} the carrier frequency. This expression comprises a number of so-called multipath components, each with different attenuations and phases.

Taking the Fourier transform with respect to τ gives the time-variant channel transfer function:

H(f;t)=FTt{h(τ;t)}=∫_{-∞}^{∞}h(τ;i)e^{j2πf}dτ.

It is usually assumed that the impulse response is wide-sense stationary, and that the attenuation and phase shifts of the individual multipath components are uncorrelated (assumption of uncorrelated scattering [2]). Under these conditions, the autocorrelation function of the time-variant channel transfer function only depends on the frequency and time differences Δf and Δt:

R(Δf;Δt)=E[H*(f;t)H(f+Δf;t+Δt)].

Setting Δf−0, R(0;Δt)≡R(Δt) is obtained. With the aid of it the time variations in the channel can be measured, which are evidenced as a Doppler broadening. By taking the Fourier transform with respect to Δt it is possible to obtain the Doppler power spectrum of the channel:

S(f_{d})=∫_{-∞}^{∞}R(Δt)e^{j2πf}^{_{d}}^{Δt}dΔt.

The width of the Doppler power spectrum gives a measure of the maximum Doppler shift due to velocity, which happens when the velocity vector is collinear with the imaginary line connecting the UE and the base station [4],[7]:

$${f}_{d , ma x} = \frac{v}{c} {f}_{c} ,$$

where v the user's velocity and c the speed of light. The coherence time is a measure of the time over which consecutive samples of the channel are sufficiently correlated. A useful rule of thumb for calculation of the coherence time is [9]:

$${T}_{c} \approx \frac{0.423}{{f}_{d , max}} .$$

Proposed structure for velocity estimation:

With this theoretical framework, the structure in FIG. 8 is proposed in an embodiment for estimating the Doppler spread and hence the user's velocity. The sampling period for the channel transfer function is denoted as ΔT and represents the time periodicity for successive collection of channel values. This magnitude must be carefully chosen so as to account for the desired range of minimum and maximum velocity values to be estimated. Some design rules are proposed in the design rules for N, M, L and ΔT section 0 for the choice of the best values in a given scenario. The inputs to the circular buffer should be the channel transfer function values H[n] . . . H_{L-1}[n] at time instant n.

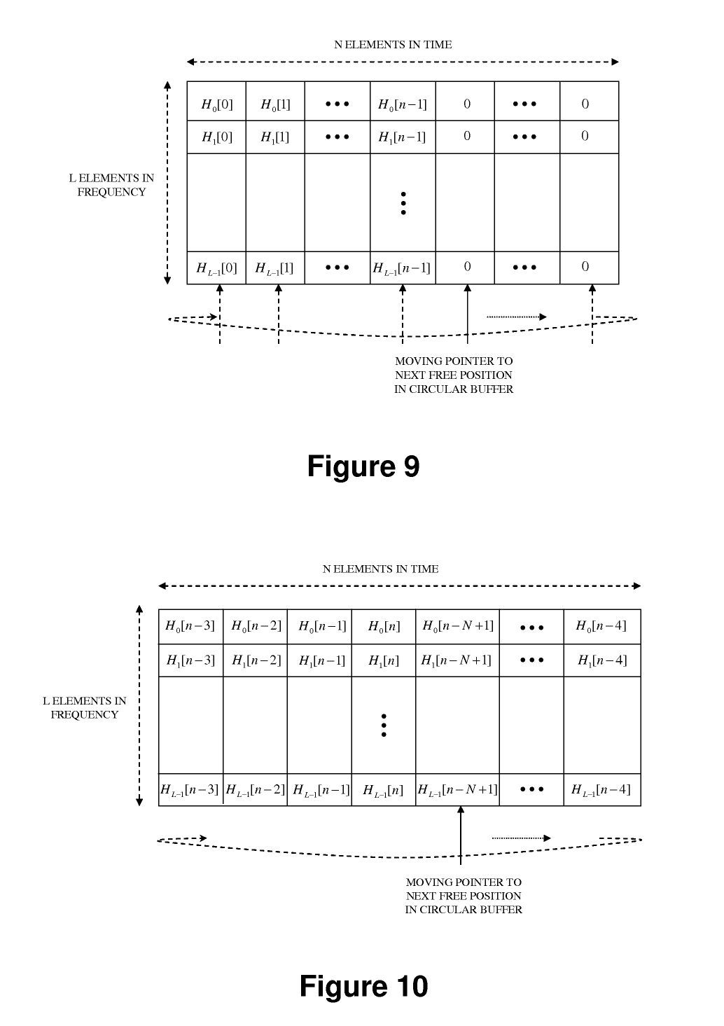

FIG. 9 represents graphically the proposed structure for the circular buffer in FIG. 8. The channel transfer function values are denoted as H₁[i], where the subscript I refers to the frequency domain and the index i to the time domain. The buffer stores a total amount of L possible frequencies and N time intervals, hence giving a total of L×N elements. Both L and N are configurable parameters depending on real needs; some values are proposed in the design rules for N, M, L and ΔT section according to a specific scenario. The time interval ΔT corresponds to the sampling period for the corresponding channel values. A moving pointer marks the next free position in the buffer, moving from left to right in the figure and coming back to the first position after reaching the last possible index (N−1). In the figure it is depicted a case where only the first n positions are filled, the other N−n positions being still free (and marked with zeros).

The value of N is related to the minimum resolvable velocity of the proposed structure, as explained in the design rules for N, M, L and ΔT section.

After storing a number of channel values greater than N, the contents of the circular buffer are as depicted in FIG. 10. The last channel values (corresponding to time n) are stored at some position in the buffer, and the next position contains the channel values corresponding to time index n−(N−1). The buffer contents in this position will be overwritten by the subsequent channel values at time n+1.

This buffer structure facilitates the calculation of the desired correlations between channel values. The expectation operator should act on both frequency and time dimensions, as correlations only depend on the relative time difference. We can calculate a first set of correlations denoted as R⁽⁰⁾[0], R⁽⁰⁾[1] . . . R⁽⁰⁾[N−1]:

$${R}^{( 0 )} [ 0 ] = E \{ {H}_{l}^{*} [ k ] {H}_{l} [ k ] \} , \\ {R}^{( 0 )} [ 1 ] = E \{ {H}_{l}^{*} [ k ] {H}_{l} [ k \vert 1 ] \} , \\ {R}^{( 0 )} [ 2 ] = E \{ {H}_{l}^{*} [ k ] {H}_{l} [ k + 2 ] \} , \\ ⋮$$

$${R}^{( 0 )} [ N - 1 ] = E \{ {H}_{l}^{*} [ k ] {H}_{l} [ k + N - 1 ] \} .$$

The first correlation is simply the average channel power and will be of no interest. Appropriate averaging over time and frequency should be applied for calculation of these values. Hence the following partial products may be defined:

$${P}_{ijl} [ 0 ] = {H}_{l}^{*} [ i ] {H}_{l} [ j ] , such that j - i = 0 , \\ {P}_{ijl} [ 1 ] = {H}_{l}^{*} [ i ] {H}_{l} [ j ] , such that j - i = 1 , \\ ⋮$$

$${P}_{ijl} [ N - 1 ] = {H}_{l}^{*} [ i ] {H}_{l} [ j ] , such that j - i = N - 1.$$

Then correlations are calculated by averaging over all possible values of indices i, j and t:

$${R}^{( 0 )} [ 0 ] = \frac{1}{{Ln}_{0}} {\sum }_{i , j , l} {P}_{ijl} [ 0 ] , \\ {R}^{( 0 )} [ 1 ] = \frac{1}{{Ln}_{1}} {\sum }_{i , j , l} {P}_{ijl} [ 1 ] , \\ ⋮$$

$${R}^{( 0 )} [ N - 1 ] = \frac{1}{{Ln}_{N - 1}} {\sum }_{i , j , l} {P}_{ijl} [ N - 1 ] .$$

The quantities nᵢ, n₁ . . . , n_{N-1} denote the number of possible i, j combinations in Pᵢⱼ. It is clear that:

nₙ=N,n₁=N−1, . . . n_{N-1}=1.

Neglecting R⁽⁰⁾[0], it is apparent that while there are L(N−1) partial products for calculation of R⁽⁰⁾[1], there are only L products for calculation of R⁽⁰⁾[N−1]. In order to avoid this difference in accuracy, we can enhance the correlation estimations by successively calculating new R values as more and more values enter the buffer, as explained below.

After L·N channel values the buffer is full and the above correlations R⁽⁰⁾[k] can be calculated. After that, subsequent channel values will overwrite existing positions in the buffer and correlations can be successively enhanced. Denoting m as an index starting with 0 when the buffer is full and incremented by one at each sampling period, new correlation values R^{(m-1)}[k] can be calculated from previous ones R^{(m)}[k] by adding L new partial products P_{i;1}[k] In the following way:

$${R}^{( m - 1 )} [ k ] - \frac{L ( {n}_{k} + m ) {R}^{( m )} [ k ] + {\sum }_{l} {P}_{ijl} [ k ]}{L ( {n}_{k} + m + 1 )} .$$

The indices i, j in the above equation are such that j−i=k and j is the position of the last stored values in the buffer. After a number M of iterations (M corresponding to the maximum value of m), the calculation stops and final correlation values R^{(Δt)}[k] can be obtained. A total amount of L(N+M) channel values will have been used for the correlations, but always keeping N−1 as the maximum time difference due to the buffer size.

The Doppler spectrum can finally be obtained after performing an N-point DFT/FFT of the obtained correlation function:

$$F [ p ] = {\sum }_{k = 0}^{N - 1} {R}^{( M )} [ k ] {e}^{j 2 {π}_{N}^{k} p} .$$

The correlation is a hermitian function, i.e. R[−k]=R*[k], and its Fourier transform is thus real. As the above summation does not cover the negative k indices, the Doppler spectrum will be given by

$$S [ p ] = {\sum }_{k = - N}^{N - 1} {R}^{( M )} [ k ] {e}^{- j 2 π \frac{k}{N} p} = 2 Re \{ F [ p ] \} , p = 0 , 1 , … , N - 1.$$

The ρ indices span from 0 to N−1 and are related to the Doppler frequencies f_{d} by the relation:

f_{d}=p·Δf.

Δf is the minimum resolvable frequency interval, which is a function of the sampling period and the length of the buffer:

$$Δ f = \frac{1}{N Δ T} .$$

Denoting pₘₐₓ as the maximum index p for which an appreciable Doppler spectrum is obtained (distinguishable from the perceived noise level), the estimated velocity will be:

$$ν = \frac{{cp}_{max} Δ f}{{f}_{c}} .$$

In practice some threshold may be applied for estimation of the maximum Doppler bandwidth, such as a given power density level (in dB) below the maximum.

The effect of a finite size DFT/FFT has implications on the resulting Doppler spectrum. Given that the theoretical continuous-time Fourier transform is by definition bandwidth-limited (the bandwidth given by the maximum Doppler frequency), a finite-size DFT gives rise to a Gibbs phenomenon similar to that appearing when trying to approximate a discontinuous function with a truncated Fourier series. An edge-enhancement method could then be applied for accurate determination of the Doppler width, such as e.g. a median filter.

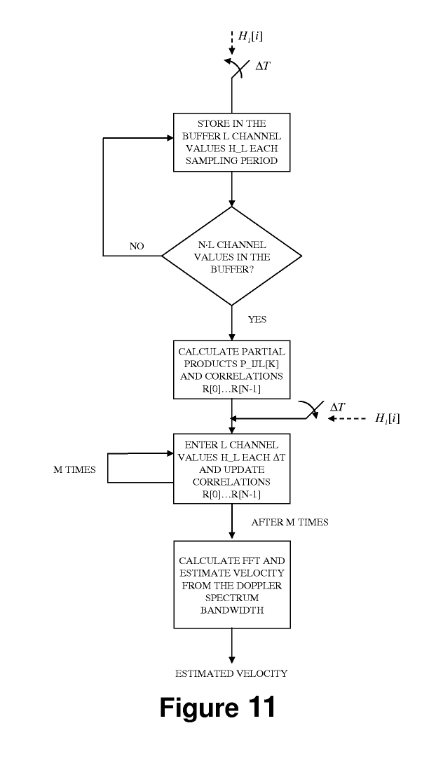

FIG. 11 depicts the simplified block diagram for velocity estimation. At each sampling period ΔT, L new channel values H₁[i] are stored in the circular buffer. After a total amount of L·N channel values the buffer is full and partial products Pᵢⱼₗ[0] . . . Pᵢⱼₗ[N−1] can be calculated, as well as initial correlations R⁽⁰⁾[0] . . . R⁽⁰⁾[N−1]. Then a process starts where, at each sampling period, L new channel values enter the circular buffer and enable updating the correlation values R^{(m)}[0] . . . R^{(m)}[N−1], for m=1, 2 . . . , M. After M iterations, final values R^{(M)}[0] . . . R^{(M)}[N−1] are obtained and the Doppler power spectrum is calculated by means of a suitable discrete Fourier transform (DFT or FFT). The Doppler bandwidth measurement gives an estimation of the user's velocity. The above process takes a total time of (N+M)ΔT seconds, and can be repeated any number of times thus resulting in a periodical velocity estimation process. Such continuous estimation can be enhanced by appropriate filtering in order to remove estimation errors. e.g. with an exponential or ARMA (Auto-Regressive Moving Average) filter.

Design rules for N, M, L and ΔT:

The value of N is related to the minimum velocity value which is resolvable by the procedure. This minimum velocity corresponds to the maximum time difference for which a correlation value is calculated, which in the proposed structure is N−1.

The minimum resolvable Doppler frequency is given by:

$$Δ f = \frac{1}{N Δ T} .$$

This gives a minimum value of the resolvable velocity, hence:

$$N > \frac{c}{{ν}_{min} {f}_{c} Δ T} .$$

However it may be desirable to consider N values greater than this minimum in order to have more precision for the estimation of low velocity values.

The sampling period ΔT is related to the maximum velocity to be estimated:

$$\begin{matrix}{f}_{d , max} - \frac{N}{2} Δ f - \frac{1}{2 Δ T} \\ {f}_{d , max} = \frac{{ν}_{max}}{c} {f}_{c}\end{matrix} \} ⇒ Δ T = \frac{c}{2 {ν}_{max} {f}_{c}}$$

A value of ΔT can therefore be calculated, which should also be greater than the coherence time of the channel given by [9]:

$${T}_{c} \approx \frac{0.423}{{f}_{d , max}} .$$

It is clear that the design condition ΔT=1/(2 f_{d,max}) ensures that the sampling period is greater than the coherence time of the channel.

The value of M is related to the difference in precision between the number of partial products for calculation of R^{(M)}[1] and R^{(M)}[N−1]. As explained in section 0, the number of partial products for calculation of the correlation values R^{(M)}[k] is L(nₖ+M). The ratio between the minimum and maximum number of partial products is thus:

$$\frac{L ( {n}_{k , min} + M )}{L ( {n}_{k , max} + M )} = \frac{1 + M}{N - 1 + M} .$$

This ratio can be regarded as the relative difference between the number of partial products for the minimum and maximum time difference. If a relative error less than ε is sought, M can be calculated in the following way:

$$\frac{1 + M}{N - 1 + M} > 1 - ɛ ⇒ M > \frac{( N - 1 ) ( 1 - ɛ ) - 1}{ɛ} .$$

This gives an estimation of the value M for which correlations R^{(M)}[1] and R^{(M)}[N−1] have a difference in accuracy less than ε %.

The total estimation time is (N+M)ΔT, and that this time should not be very large in order to keep the shadowing properties of the channel relatively unchanged. The shadowing correlation distance can vary from 10 m in urban environments to 500 m in suburban areas [4]. Hence the distance covered at the minimum resolvable velocity should not be higher than the correlation distance, to avoid distortion for the highest time difference NΔT (corresponding to the minimum resolvable velocity).

Finally, the number L of channel samples in the frequency dimension may be obtained considering the minimum required number of partial products in the correlation calculations. This minimum number is L(1+M), from which it is possible to derive L after having obtained M.

An example for the case of an LTE access network operating at a carrier frequency of 2600 MHz can illustrate the design process. The channel transfer function can be obtained from cell reference signals, which are spaced 0.25 ms on average (there are two sets of cell reference signals in each 0.5-ms slot). Hence ΔT will be in this case a multiple of 0.25 ms.
Sampling period: if velocities up to 100 km/h are to be estimated by the system, application of the above described formulas gives a sampling period not higher than 2.07 ms. It is therefore advisable to consider ΔT=2 ms, or a channel sample every two subframes.
Value of N: if the minimum resolvable velocity is 3 km/h, this gives a minimum value of N=69. In order to have more precision, it is possible to consider N=128 (256 ms).
Value of M: assuming a difference in precision of ε=10% between the maximum and minimum number of partial products, the value of M will be 1133. Taking M=1280 the resulting time interval for velocity estimation will be 2.81 s. This can also be regarded as the minimum interval for velocity reporting in connected mode. The distance covered at the minimum velocity of 3 km/h is just 2.34 m, much lower than typical correlation distances.
Value of L: considering that the minimum number of partial products is L(1+M)=1281·L, if 10000 channel values are required this gives a value of L=8 samples. It is to note however that there is more freedom in the choice of L, and can be based on actual implementation needs.

The above calculations serve as an example and do not preclude any other design choice, taking into account implementation needs and actual constraints.

Simulation results for the proposed velocity estimation method:

The proposed velocity estimation mechanism has been simulated in the downlink of an LTE link level simulator, in order to validate that the proposed ideas can be implemented in a user's mobile device. Table 1 summarizes the main parameters and assumptions.

TABLE 1
Parameters for velocty estimation

| Parameter | Setting |
|---|---|
| Carrier frequency | 2.6 GHz |
| System bandwidth | 20 MHz |
| Power delay profile | ITU Extended Pedestrian A (EPA), ITU Extended |
| | Vehicular A (EVA) |
| Ricean K-factor | −∞, −10 dB |
| Shadow fading | Not present |
| Channel estimation | Ideal |
| N | 128 |
| M | 1280 |
| L | 10 |
| ΔT | 2 ms |
| Threshold for | −6 dB power level below the maximum |
| bandwidth | |
| detection | |
| SNR | 0, 5, 10, 15, 20, 25, 30 dB (10 snapshots for each SNR |
| | and velocity) |
| UE speed | 3, 30, 50, 70 and 100 km/h |

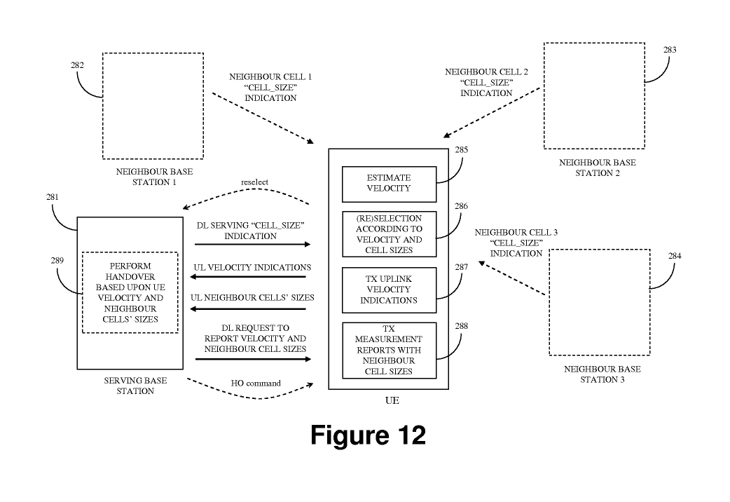

FIG. 12 depicts an exemplary embodiment for the proposed invention, characteristic of a wireless mobile communication system.

The depicted scenario for the proposed embodiment comprises a collection of base stations and a user terminal. One of the base stations is the serving base station (block 281), while the others are neighbour base stations (blocks 282, 283 and 284). All of them broadcast suitable cell size indications through parameter “CELL_SIZE”. with any defined granularity. The UE thus reads and decodes the cell size indications from all the cells, while additionally performing velocity estimation (block 285). This velocity estimation, as well as the broadcast cell sizes, are inputs for a mobility-based cell selection and reselection strategy (block 286), aimed at selecting the most suitable cell according to the user's velocity and the cell sizes. After entering connected mode, and upon request from the serving base station, the UE sends uplink velocity indications (block 287) and measurement reports containing neighbour cells' sizes (block 288). Both these can be used by the serving base station in order to perform mobility-based handover decisions (block 289).

The proposed embodiment can be Implemented as a collection of software elements, hardware elements, firmware elements or any suitable combination.

### Advantages of the Invention

The proposed invention introduces mobility-based procedures for cell selection and handover, based on the interaction between the network and the user terminal. Heterogeneous networks demand advanced radio resource management algorithms based on velocity estimation, and mobility-based handover and reselection decisions are a must for multi-layer load balancing strategies. Mobility information is usually based on the number of reselections and handovers performed during a time interval, being thus effective only after a number of cell changes which may result in too-early, too-late or failed handovers.

The proposed invention introduces a mechanism for broadcast cell size indications by the base stations, and suitable reporting procedures between the UE and the network. These enhancements help to discriminate between different candidate cells for cell reselections and handovers, especially when the user's velocity is significant. By keeping fast moving users in macro layers and static users in small cells layers (whenever possible), the number of signaling messages and handovers can be greatly reduced. Velocity and neighbour cells' sizes can be valuable inputs for data scheduling, mobility-based load balancing and any other RRM strategy. Moreover, the broadcast of cell sizes allows a multitude of terminal-based strategies for cell selection other than those based on mobility, such as e.g. reserving small hot spots for high-end terminals or moving legacy UEs to the macro layer whenever possible.

It is to be understood that the above description is intended to be illustrative and not restrictive. Many variations of the proposed invention will be apparent to those skilled in the art upon reviewing the above description. The goal of the present invention should be determined with reference to the appended claims, along with the full scope of equivalents to which such claims are entitled.

### ACRONYMS

ARMA Auto Regressive Moving Average
BCCH Broadcast Control Channel
CPICH Common Pilot Channel
CRE Cell Range Expansion
CRS Cell Reference Signal
DFT Discrete Fourier Transform
DRX Discontinuous Reception
FFT Fast Fourier Transform
HetNet Heterogeneous Network
IE Information Element
IEEE Institute for Electrical and Electronics Engineering
LOS Line of Sight
LTE Long Term Evolution
NAS Non-Access Stratum
NLOS Non Line of Sight
RAT Radio Access Technology
RRC Radio Resource Control
RRM Radio Resource Management
RX Reception
SNR Signal to Noise Ratio
SRS Sounding Reference Signal
TTT Time to Trigger
TX Transmission
UE User Equipment
UMTS Universal Mobile Telecommunication System

### REFERENCES

[1] S. Sesia, I. Toufik, M. Baker (editors), “LTE. the UMTS Long Term Evolution: From Theory to Practice”. 2nd edition, John Wiley & Sons, 2011
[2] J. G. Proakis, “Digital Communications”, 4th edition, McGraw-Hill
[3] H. Zhang and A. Abdi, “Cyclostationarity-based Doppler Spread Estimation in Mobile Fading Channels”, IEEE Global Telecommunications Conference, San Francisco, Calif., 2006
[4] C. Tepedelenlioglu et al, “Estimation of Doppler spread and signal strength in mobile communications with applications to handoff and adaptive transmission”, Wirel. Commun. Mob. Comput. 2001, 1:221-242, Wiley
[5] 3GPP TS 36.304, “Evolved Universal Terrestrial Radio Access (E-UTRA); User Equipment (UE) procedures in idle mode (Release 10)”
[6] 3GPP TS 36.331, “Evolved Universal Terrestrial Radio Access (E-UTRA); Radio Resource Control (RRC); Protocol specification (Release 10)”
[7] C. Tepedelenlioglu and B. Giannakis, “On velocity estimation and correlation properties of narrow-band mobile communication channels”, IEEE Trans. Veh. Techn., vol. 50. no. 4, July 2001
[8] 3GPP TS 36.211, “Evolved Universal Terrestrial Radio Access (E-UTRA); Physical Channels and Modulation (Release 10)”
[9] M. Ergen, “Mobile Broadband: Including Wimax and LTE”, Springer, 2009
[10] A. Damnjanovic et al, “A Survey on 3GPP Heterogeneous Networks”, IEEE WIreless Communications, June 2011

1.-15. (canceled)

16. A method for reducing signaling messages and handovers in wireless networks, comprising estimating, at least one wireless user device (UE) its own velocity from at least one downlink pilot signal being transmitted by any base station from a plurality of different base stations, characterized in that it further comprises:
broadcasting each one of said plurality of different base stations a parameter relative to its own cell size;
performing said at least one wireless user device in idle mode cell selections and reselections based on said plurality of base station cell size parameters received and said at least one wireless user device estimated velocity; and
reporting, said at least one wireless user device in connected mode, said estimated velocity and the cell sizes of neighboring base stations to a serving base station in order to perform handovers based on said reported estimated velocity and said neighboring base station cell sizes, wherein the cell sizes of neighboring base stations being reported as part of the measurement reports upon request from said serving base station.

17. A method according to claim 16, characterized in that when said at least one wireless user device estimated velocity is above a given threshold indicative of fast moving conditions said cell reselection is limited to large or medium-size cell base stations and said serving base station performs said handovers in order to steer said at least one wireless user device to said large or medium-size cell base station.

18. A method according to claim 16, characterized in that when said at least one wireless user device estimated velocity is below a given threshold indicative of static conditions said cell reselection is limited to a small-size cell base station, and said serving base station performs said handovers in order to steer said at least one wireless user device to said small-size cell base station.

19. A method according to claim 16, characterized in that said base station cell size parameter is broadcasted as part of a suitable information element (IE) contained within a Broadcast Control Channel (BCCH) in a UMTS or in a LTE network.

20. A method according to claim 16, characterized in that said base station cell size parameter is broadcasted in a separate information element.

21. A method according to claim 19, characterized in that said base station cell size parameter is a relative measure of the effective cell size considering a transmission power and a carrier frequency.

22. A method according to claim 21, characterized in that it comprises expressing said base station cell size in terms of a useful measure such as an average surface area, an identifier taken from a list of possibilities or half the distance to the nearest neighbour, among others.

23. A method according to claim 16, characterized in that it comprises sending said at least one user device estimated velocity in a periodic way in a suitable uplink control/data channel upon request from said serving base station.

24. A method according to claim 16, characterized in that it comprises sending said at least one wireless user device estimated velocity in an aperiodic way in a suitable uplink control/data channel upon request from said serving base station.

25. A method according to claim 16, characterized in that said at least one wireless user device estimated velocity is calculated based upon observation of a downlink cell reference signal selected among LTE cells, a Common Pilot Channel (CPICH) in UMTS/HSPA cells or a pilot in a radio access technology.

26. A method according to claim 19, characterized in that said downlink pilot signals are constantly broadcasted by said plurality of base stations and in that in order to calculate said at least one wireless user device estimated velocity it comprises finding an estimated maximum Doppler frequency from said downlink pilot signals by performing a Fourier transform of the autocorrelation of a channel transfer function H(f;t) calculated from said downlink pilot signals.

27. A method according to claim 26, characterized in that the process to calculate said at least one wireless user device estimated velocity takes a total time of (N+M)ΔT seconds, and is repeated a number of times thus resulting in a periodical velocity estimation process, where ΔT is the sampling period for the channel transfer function related to the maximum velocity value to be estimated, N is related to a minimum resolvable velocity value corresponding to a maximum time difference for which a correlation value is calculated, and M is related to the difference in precision between a number of partial products for calculation of said correlation values.

28. A method according to claim 27, characterized in that it further comprises applying a filter to said periodical velocity estimation process in order to remove estimation errors.

29. A method according to claim 27, characterized in that in order to maintain shadowing properties of said channel unchanged at the minimum resolvable velocity, said total time is kept at a low value by achieving that the distance covered by the at least one wireless user device at the minimum resolvable velocity over said total time is not higher than the correlation distance.
